(19) United States
(12) Patent Application Publication
(10) Pub. No.: US 2010/0163191 A1
(43) Pub. Date: Jul. 1, 2010

(54) PROTECTIVE SHUTTER ASSEMBLY FOR A DOOR OR WINDOW

(76) Inventor: Alex Homery, Palm Bay, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/645,395

(22) Filed: Dec. 22, 2009

Related U.S. Application Data
(60) Provisional application No. 61/139,727, filed on Dec. 22, 2008.

(51) Int. Cl. E06B 9/02; B28B 3/20

(52) U.S. Cl. 160/236; 264/297.1

(57) ABSTRACT

A protective shutter assembly is provided for a door and/or a window. The shutter assembly includes a plurality of interfitted shutter slats, where each slat has an intermediate portion and a first and second end. The first and second ends take a curvilinear shape, where the first end of a first shutter slat is rotatably coupled to the second end of a second shutter slat. The first end of the first shutter slat is secured to the second end of the second shutter slat and an angle between the first and second shutter slat is adjustable between a minimum angle at an open position and a maximum angle at a closed position.

### RELATED APPLICATIONS

This patent application claims benefit of the Provisional Patent Application No. 61/139,727 filed on Dec. 22, 2008.

### FIELD OF THE INVENTION

The present invention relates in general to protective shutters for windows, doors and the like, and is particularly directed to an accordion type shutter that is comprised of a plurality of interfitting, generally rectilinear slats having curvilinear end portions.

### BACKGROUND OF THE INVENTION

FIG. 1 is a diagrammatic plan or end view of a conventional accordion type window and door track-supported shutter, which has generally box or square type joints between respective shutter slats. As shown therein, in their fully deployed or closed configuration, the individual shutter slats, which are customarily made of extruded aluminum, engage one another at ninety degree angles so as to form a series of interlocking ‘V’s 10. Although such shutters are effective in covering a door or window, the fact that the respective shutter slats interlock with one another at ninety degree angles means that the effective (projected) coverage area of an individual shutter slat is substantially less than (e.g., on the order of only seventy percent of) the actual width dimension W of the shutter slat. Thus, the cost of the materials necessary to cover a window is relatively expensive, as compared to an arrangement in which each shutter slat covers a greater respective length of the window or door.

Accordingly, it would be advantageous to provide a window and/or door shutter, that addresses the shortcomings of the conventional shutter discussed above, and is capable of covering a window and/or door opening with less material, thereby minimizing the cost of the shutter.

### BRIEF DESCRIPTION OF THE INVENTION

In one embodiment of the present invention, a protective shutter assembly is provided for a door and/or a window. The shutter assembly includes a plurality of interfitted shutter slats, where each slat has an intermediate portion and a first and second end. The first and second ends have a curvilinear shape, where the first end of a first shutter slat is rotatably coupled to the second end of a second shutter slat. The first end of the first shutter slat is secured to the second end of the second shutter slat and an angle between the first and second shutter slat is adjustable between a minimum angle at an open position and a maximum angle at a closed position.

In another embodiment of the present invention, a protective shutter assembly is provided for a door and/or a window. The shutter assembly includes a first plurality of interfitted shutter slats and a second plurality of interfitted shutter slats. Each plurality of slats includes a respective mate slat, where a first end of the mate slat of the first slats takes a cross-sectional shape, and a second end of the mate slat of the second slats has an opening to receive the cross-sectional shape, to secure the first and second plurality of slats.

Each shutter slat has an intermediate portion and a first and second end, where the first and second end take a C-shaped curvilinear shape. An inner diameter of the C-shaped curvilinear shape of the second end is greater than an outer diameter of the curvilinear shape of the first end, such that the curvilinear shape of the first end of a first slat is rotatable within the curvilinear shape of the second end of a second slat and the first and second slat are secured within a respective plurality of interfitted shutter slats. An angle between the first and second slats among the respective plurality of shutter slats is adjustable between a minimum angle at an open position to a maximum angle at a closed position.

In another embodiment of the present invention, a method is provided for forming a protective shutter assembly for a door and/or a window. The method includes providing a plurality of interfitted shutter slats, followed by shaping each shutter slat with a curvilinear first and second end. The method further includes rotatably coupling the first end of a first slat with the second end of a second slat, such that the first end of the first slat is secured to the second end of the second slat. The method further includes adjusting an angle between the first and second shutter slat between an open position and a closed position.

### BRIEF DESCRIPTION OF THE DRAWINGS

FIG. 1 is an end view of a typical prior art accordion type window and door track-supported shutter, which has generally square type joints between respective shutter slats;

FIG. 2 shows an end view of an individual shutter slat in accordance with the present invention;

FIG. 3 shows an end view of a pair of shutter slats of FIG. 2 in their open or nested position;

FIG. 4 shows an end view of a pair of shutter slats of FIG. 2 in their closed position;

FIG. 5 is an end view of a center-mate slat used to join respective sections of shutter slats as configured in FIGS. 2-4;

FIG. 6 is an end view of a terminal fastener strip used to terminate a respective section of the shutter assembly in accordance with FIGS. 2-5;

FIG. 7 shows the overall assembly of the shutter components of FIGS. 2-6 for the open configuration of the shutter; and

FIG. 8 shows the overall assembly of the shutter components of FIGS. 2-6 for the closed configuration of the shutter.

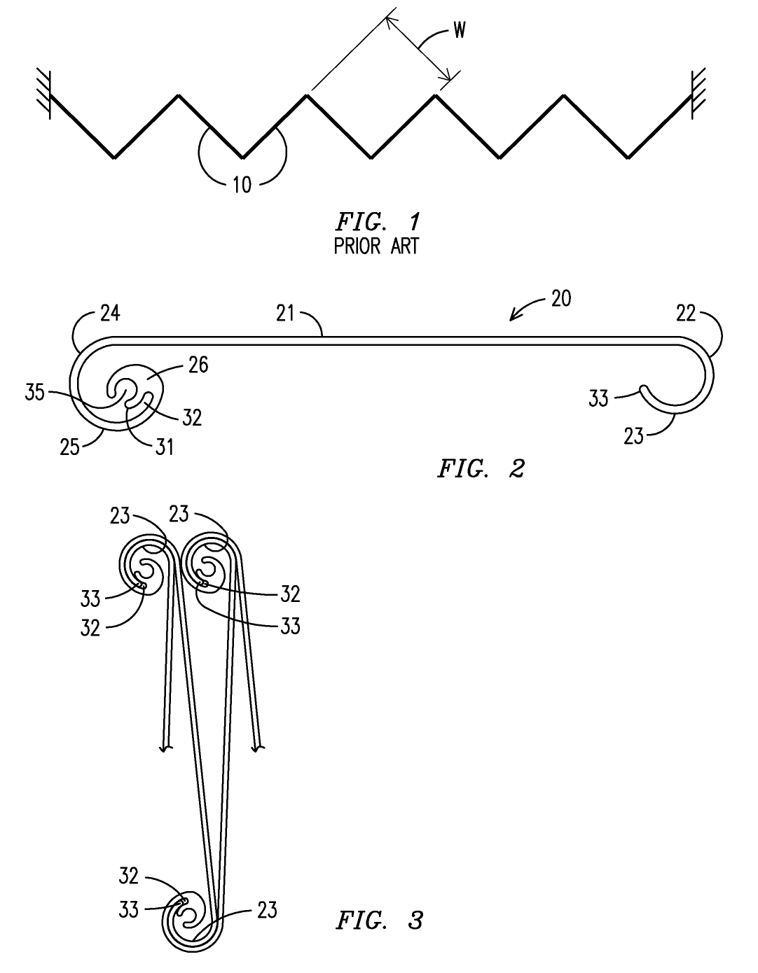

### DETAILED DESCRIPTION

Before describing in detail the particular methods and apparatuses related to window and door shutters, it should be observed that the present invention resides primarily in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the invention. The following embodiments are not intended to define limits as to the structure or method of the invention, but only to provide exemplary constructions. The embodiments are permissive rather than mandatory and illustrative rather than exhaustive.

As previously discussed, conventional shutters feature slats that are not capable of forming a respective angle beyond about 90 degrees with respect to one another when the shutter is in the closed position. Thus, it would be advantageous to provide a shutter that features segments or slats that have an adjustable angle with respect to one another, including an angle greater than about 90 degrees, thereby allowing a greater coverage area for each shutter slat, and thereby reducing the material and/or cost required for such a shutter. For efficient coverage it is desired that as much shutter material as possible serve the purpose for which the shutter is intended—namely, to cover and protect the area behind it. Generally, the present invention requires two shutters to cover the door or window. Each shutter comprises a plurality of interfitting slats, each slat having a length slightly shorter than a height of the window or door (for a shutter assembly that is deployed horizontally to cover the window or door) or each having slat a length slightly shorter than a width of the window or door (for a shutter assembly that is deployed vertically to cover the window or door).

In accordance with the present invention, this objective is successfully addressed by a new and improved track-supported, accordion type shutter comprised of interfitting slats having interfitting curvilinear end portions that form interlocking curvilinear channels. As will be described herein, these curvilinear channels allow the slats to be compactly stacked or nested against one another in the open configuration of the shutter, and expandable from their stowed configuration such that two successive slats are disposed in a linear or nearly linear orientation in the closed or deployed configuration of the shutter. In such a deployed configuration, the angle between two successive slats is greater than 90 degrees as is known in the prior art.

The embodiments of the present invention discuss an “open” and “closed” position of the window/door shutter. The “open” position is defined as a position of the shutter in which successive shutter slats have a minimal spacing therebetween, while the “closed” position is defined as a position in which successive shutter slats have a maximum spacing therebetween. In an exemplary embodiment, the “open” position may be employed when a door and/or window is open, such that the shutter is moved away from a center region of the door and/or window to a respective side of the door and/or window so not to obstruct the opening. As a result of moving the shutter to a respective side of the door and/or window, the shutter slats are placed in a more closely spaced orientation. In an exemplary embodiment, the “closed” position may be employed when a door and/or window is closed, such that the shutter is moved toward the center portion of the door and/or window and away from a respective side of the door and/or window. The shutter may be placed in this orientation to protect the door or window from wind-blown debris, for example. As a result of moving the shutter away from the sides of the door and/or window, the shutter slats assume a spaced-apart orientation, when compared with the open orientation, and the angle between adjacent slats increases.

More particularly, FIG. 2 shows an end view of an individual shutter slat or slat 20 in accordance with the invention having a generally rectilinear portion 21, which is terminated at a first end 22 thereof by a first generally curvilinear or ‘C’-shaped portion 23, and at a second end 24 thereof by a second ‘C’-shaped portion 25 that is terminated by a generally circular land portion 26. The generally circular land portion 26 is shown as having a generally curvilinear finger-like portion 31 that is spaced apart from and generally parallel to the ‘C’-shaped portion 25 so as to form a generally curvilinear channel 32 therebetween.

As shown in FIG. 3 wherein two adjacent slats are mated, the width of the channel 32 is sized to accommodate the end 33 of the ‘C’-shaped portion 23 of an adjacent shutter slat. Adjacent to the generally curvilinear finger-like portion 31 is a generally circular aperture or bore 35, which is sized to receive a fitting, such as a self-tapping screw, that is used to attach a track wheel assembly (not shown), for enabling the shutter slat to be supported by and travel along a shutter track of conventional configuration.

Although FIG. 2 illustrates that the first and second ends 22,24 of the shutter slats 20 feature a ‘C’-shaped curvilinear portion, the ends may take any curvilinear form, and need not take a strictly ‘C’-shaped form. Additionally, the channel 32 need not be formed between the finger-like portion 31 and the ‘C’-shaped portion 25, and instead may be formed anywhere within the second end 24, so to receive the end 33 of the ‘C’-shaped portion 23.

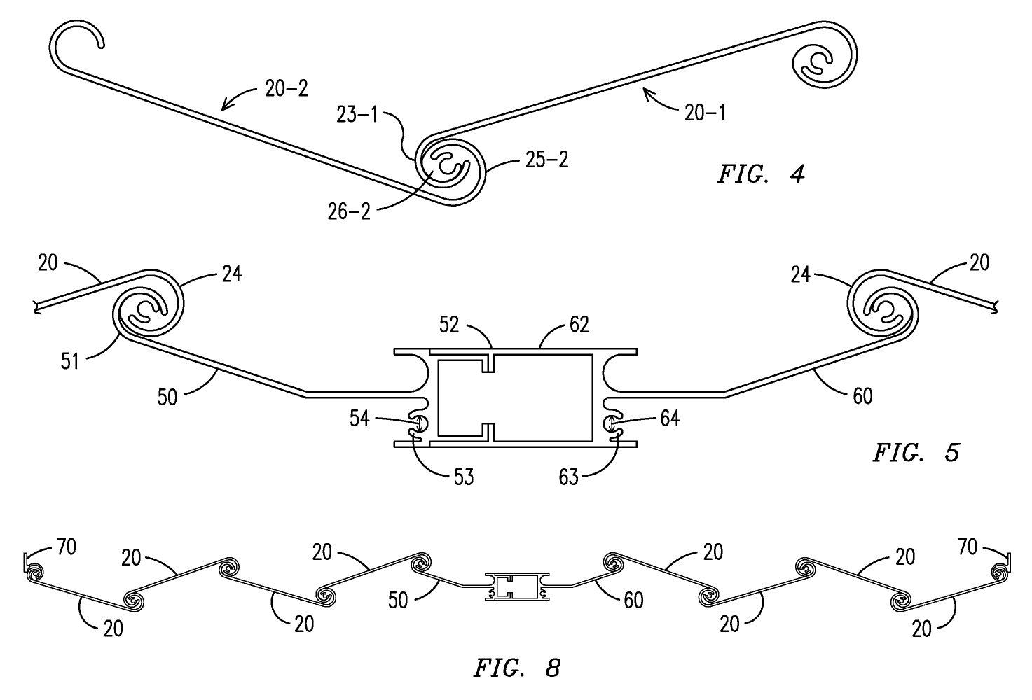

As further shown in FIG. 4, which is an end view of a pair of mutually engaged shutter slats 20-1 and 20-2, in their extended or closed configuration, the inner diameter of the generally curvilinear or ‘C’-shaped portion 23-1 of slat 20-1 is proximate, but slightly larger than, the outer diameter of the generally circular land portion 26-2 of slat 20-2 to allow the ‘C’-shaped portion 23-1 of slat 20-1 to rotate around the generally circular land portion 26-2 of slat 20-2. In a complementary fashion, the inner diameter of the ‘C’-shaped portion 25-2 of shutter slat 20-2 is proximate, but slightly larger than, the outer diameter of the ‘C’-shaped portion 23-1 of slat 20-1, so as to allow the ‘C’-shaped portion 23-1 to rotate relative to the ‘C’-shaped portion 25-2.

As previously discussed, the ends of the slats 20-1, 20-2 need not be C-shaped nor curvilinear, and thus the slat 20-1 need not be configured to “rotate” around the slat 20-2. The ends of the slats 20-1,20-2 may take the form of any polygon shape, the angle between the slats 20-1,20-2 may be varied, as the slats 20-1,20-2 move relative to one another, based on the particular form of the ends of the slats 20-1,20-2.

FIG. 5 is an end view of a center-mate slat assembly used to join respective sections of shutter slats as configured in FIGS. 2-4. As shown therein, a male center-mate slat 50 has a first end 51 configured in the manner of the end 22 of an individual shutter slat 20 shown in FIG. 2, so that it may engage the second end 24 of an adjacent shutter slat 20. The center-mate slat 50 also has a second end 52 of a generally rectangular shape and sized to fit within and engage an associated second, generally rectangular end 62 of a female center-mate slat 60.

The female center-mate slat 60 has a first end 61 also configured in the manner of the end 22 of an individual shutter slat 20 shown in FIG. 2, so that it may engage the second end 24 of an adjacent shutter slat 20, as shown. The generally rectangularly shaped center-mates 50 and 60 also include respective ‘C’ shaped regions 53 and 63, having inner diameters that are sized to receive fittings, such as self-tapping screws, that are used to attach the center-mate slats to a track wheel assembly for the shutter, as described above.

Although the embodiment of FIG. 5 illustrates a rectangular end 52 of the center-mate slat 50 and a rectangular end 62 of the center-mate slat 60 with a rectangular opening to receive the rectangular end 52, the embodiments of the ends 52,62 of the center-mate slats 50,60 are not limited to a rectangular configuration, but may take the form of any polygon. Additionally, the embodiment of FIG. 5 need not include the ‘C’-shaped regions 53,63, or may include a region having a varied form other than ‘C’-shaped to attach a track wheel assembly for the shutter.

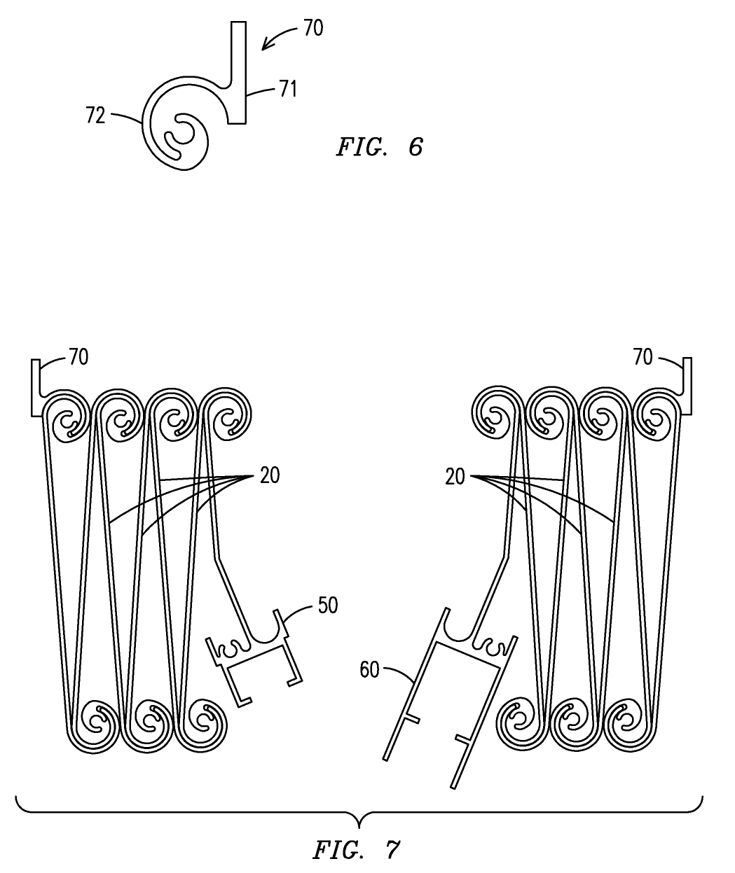

FIG. 6 is an end view of a terminal fastener strip 70 used to terminate a respective section of the shutter assembly in accordance with FIGS. 2-5. As shown therein terminal fastener strip 70 has a first generally L-shaped end 71 that is sized to receive fittings for attaching the terminal fastener strip to a shutter mounting frame and the like. Extending from the first end 71 is a generally ‘C’-shaped portion 72 the shape of which corresponds to the generally circular land portion 26 of a respective shutter slat as described above with reference FIG. 2.

The end 71 need not be L-shaped, nor does the end 71 need to receive a fitting to attach to a shutter mounting frame. Instead, the end 71 may be attached to the shutter mounting frame using any attachment means, such as an adhesive, for example. Additionally, the portion 72 of the fastener strip 70 need not be ‘C’-shaped, and may take a similar form as the slats 20, as discussed above.

FIG. 7 shows the overall assembly of the shutter components described above for the open configuration of the shutter, while FIG. 8 shows the overall assembly of the shutter components described above for the closed configuration of the shutter. As can be seen from these Figures, a shutter assembly formed of the shutter slat components of the present invention is stowable to a highly nested open configuration (FIG. 7), and is deployable to a closed configuration that allows the shutter slats to be nearly parallel (or linear) with one another, thereby substantially increasing the coverage area per shutter slat. In the embodiment of FIG. 8 (closed position), the respective slats 20 form a respective angle with one another that exceeds 90 degrees and is nearly 180 degrees.

Among the many advantages of the shutter assembly of the present invention are:

1. The slats are configured to be extrudable.

2. A center to center distance between two consecutive slats is greater than prior art shutter systems.

3. As a result of 2. an installation requires fewer slats than prior art systems

4. Fewer fasteners and hardware (screws, wheels, bushings, etc.) are required for the shutter of the present invention than for prior art shutter systems.

5. Average shorter assembly time than for prior art systems.

6. The shutter can be locked from either the inside or the outside.

7. The shutter may be pre-assembled for quicker installation.

8. Due to the simpler dimensioning of the shutter of the present invention, estimating sizes and fabrication is easier.

9. In one embodiment clear Lexan shutter slats are used.

The shutter of the present invention can be configured and mounted to open/close in a horizontal or a vertical direction. That is, the two shutter segments can be deployed vertically downwardly and upwardly toward a center region where the two portions are joined, or deployed from the sides toward a center region where the two portions are joined.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A protective shutter assembly for one of a door and a window, said shutter assembly comprising:
a plurality of interfitted shutter slats, each slat having an intermediate portion and a first and second end, said first and second ends taking a curvilinear shape; and
the curvilinear shape of said first and second ends each shaped to rotatably couple said first end of a first slat to said second end of a second slat, such that an angle between the first and second shutter slat is adjustable between a minimum angle at an open position and a maximum angle at a closed position.

2. The protective shutter assembly of claim 1, wherein said intermediate portion takes a rectilinear shape, said first and second ends include a C-shaped portion, said C-shaped portion of the second end includes a land portion having a finger portion spaced apart from the C-shaped portion of the second end to form a channel, wherein an arc tip of the C-shaped portion of the first end is configured to be received within the channel of the second end, permitting adjustment of the angle between the first and second shutter slats to the minimum angle at the open position.

3. The protective shutter assembly of claim 1 wherein the maximum angle is greater than about 90 degrees.

4. The protective shutter of claim 3 wherein a shape and a curvature of the first and second ends are selected to achieve the maximum angle greater than about 90 degrees.

5. The protective shutter assembly of claim 1, wherein an inner diameter of the curvilinear shape of the second end is greater than an outer diameter of the curvilinear shape of the first end, such that the curvilinear shape of the first end is rotatable within the curvilinear shape of the second end.

6. The protective shutter assembly of claim 1, wherein the curvilinear shape of the second end includes an interior portion, said interior portion taking a curvilinear shape, and wherein an inner diameter of the curvilinear shape of the first end is greater than an outer diameter of the curvilinear shape of the interior portion, such that the curvilinear shape of the interior portion is rotatable within the curvilinear shape of the first end.

7. The protective shutter assembly of claim 6, wherein the interior portion includes a finger portion, said finger portion being spaced apart from the curvilinear shape of the second end to form a channel, wherein the channel is configured to receive an arc tip of the curvilinear shape of the first end based on the rotation of the curvilinear shape of the first end within the curvilinear shape of the second end such that the angle between the first and second shutter slat is adjusted to the minimum angle at the open position.

8. The protective shutter assembly of claim 7, and wherein the arc tip of the curvilinear shape of the first end is configured to exit from the channel, based on the rotation of the curvilinear shape of the first end within the curvilinear shape of the second end, where said rotation provides adjustment of the angle between the first and second shutter slats to the maximum angle at the closed position.

9. The protective shutter assembly of claim 1, including a first plurality of interfitted shutter slats and a second plurality of interfitted shutter slats, wherein a first end of a mate slat of the first plurality of slats takes a cross-sectional shape, and wherein a second end of a mate slat of the second plurality of slats has an opening configured to receive the cross-sectional shape of the mate slat of the first plurality of slats to secure the first and second plurality of interfitted shutter slats.

10. The protective shutter assembly of claim 9, further comprising a respective terminal fastener strip configured to mount the first and second plurality of interfitted shutter slats to a mounting frame, said terminal fastener strip including a first end sized to receive a fitting to secure the fastener strip to the mounting frame, and a second end taking the curvilinear form of the second end of the shutter slat, said curvilinear form of the second end of the respective fastener strip being rotatably coupled to the curvilinear form of the first end of a respective mount slat positioned opposite from the mate slat within the respective plurality of interfitted slats.

11. A protective shutter assembly for one of a door and window, said shutter assembly comprising:
a first plurality of interfitted shutter slats;
a second plurality of interfitted shutter slats;
each plurality of slats including a respective mate slat, a first end of the mate slat of the first plurality of slats to take a cross-sectional shape, a second end of the mate slat of the second plurality of slats having an opening configured to receive the cross-sectional shape, and secure the first and second plurality of slats together;
each shutter slat having an intermediate portion and a first and second end, said first and second end taking a C-shaped curvilinear shape;
wherein an inner diameter of the C-shaped curvilinear shape of the second end is greater than an outer diameter of the curvilinear shape of the first end, such that the curvilinear shape of the first end of a first slat is rotatable within the curvilinear shape of the second end of a second slat; and
and wherein an angle between said first and second slats among the respective plurality of shutter slats is adjustable between a minimum angle at an open position to a maximum angle at a closed position.

12. The protective shutter of claim 11, wherein the curvilinear shape of the second end of the second slat includes an interior portion, said interior portion taking a curvilinear shape, and wherein an inner diameter of the curvilinear shape of the first end of the first slat is greater than an outer diameter of the curvilinear shape of the interior portion, such that the curvilinear shape of the interior portion of the second slat is rotatable within the curvilinear shape of the first end of the first slat.

13. The protective shutter assembly of claim 11, wherein the maximum angle at the closed position is greater than 90 degrees.

14. A method for forming a protective shutter assembly for one of a door and a window, said method comprising:
extruding a plurality of shutter slats;
shaping each shutter slat with a curvilinear first and second end;
rotatably coupling the first end of a first slat with the second end of a second slat; and
adjusting an angle between the first and second shutter slat between an open position and a closed position.

15. The method of claim 14, wherein said shaping comprises shaping each shutter slat with a C-shaped first and second end, and forming a channel in the C-shaped second end, based on forming a land portion in the second end that has a finger portion spaced apart from the C-shaped portion, said method further includes forming an intermediate rectilinear portion between the first and second C-shaped portion, and adjusting the angle such that an arc tip of the C-shaped portion of the first end is received within the channel.

16. The method of claim 14, wherein said shaping comprises adjusting an inner diameter of the curvilinear shape of the second end to be greater than an outer diameter of the curvilinear shape of the first end, and rotating the curvilinear shape of the first end within the curvilinear shape of the second end.

17. The method of claim 16, wherein said shaping includes forming an interior portion within the curvilinear shape of the second end, where an inner diameter of the curvilinear shape of the first end is greater than an outer diameter of the curvilinear shape of the interior portion; and rotating the curvilinear shape of the interior portion within the curvilinear shape of the first end.
